(19) United States
(12) Patent Application Publication
(10) Pub. No.: US 2008/0261651 A1
(43) Pub. Date: Oct. 23, 2008

(54) MULTI-MODE COMMUNICATION APPARATUS FOR SELECTIVELY USING W-CDMA SYSTEM AND GSM SYSTEM

(76) Inventors: Yusuke NAKAHASHI, Osaka (JP); Naoki OKAMOTO, Osaka (JP); Junji ITO, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/014,402

(22) Filed: Jan. 15, 2008

(30) Foreign Application Priority Data
Jan. 15, 2007 (JP) 2007-5632

(51) Int. Cl. H04M 1/02

(52) U.S. Cl. 455/553.1

(57) ABSTRACT

In a multi-mode communication apparatus including independent transmitter circuits and receiver circuits of a W-CDMA system and a GSM system, which are capable of complying with communication systems of the W-CDMA system and the GSM system, a first switching device is connected between a ground and an input terminal of a first low-noise amplifier of the receiver circuit of the W-CDMA communication system, and is selectively turned on and off in accordance with a first control signal. A second switching device is connected between the ground and an input terminal of a second low-noise amplifier of the receiver circuit of the GSM communication system, and is selectively turned on and off in accordance with a second control signal. A control circuit generates and outputs first and second control signals for controlling turning-on and -off of the first and second switching devices, respectively.

### BACKGROUND OF THE INVENTION

1. Field of the Invention

The present invention relates to a multi-mode communication apparatus for use in a mobile communication system or the like, and in particular, to a multi-mode communication system that shares a plurality of communication systems such as mobile communication terminals compliant with W-CDMA/GSM.

2. Description of the Related Art

Mobile communication terminals have been developed in functions in accordance with the recent development of mobile communication, and in particular, in order to comply with a variety of services, a multi-mode mobile communication terminal compliant with a plurality of communication systems by one mobile communication terminal has been needed. As a multi-mode mobile communication apparatus as described above, an apparatus including a transmitter circuit and a receiver circuit which are independently provided so as to correspond to each communication system has been known.

FIG. 1 shows a block diagram of a wireless circuit of a conventional multi-mode communication apparatus compliant with W-CDMA/GSM. Referring to FIG. 1, the multi-mode communication apparatus includes a transmitter circuit 8 for performing a transmission processing during communication in a W-CDMA communication system, a receiver circuit 9 for performing a receiving processing during communication in the W-CDMA communication system, a transmitter circuit 10 for performing a transmission processing during communication in a GSM communication system, a receiver circuit 11 for performing a receiving processing during communication in the GSM communication system, a low-noise amplifier (LNA) 6 for amplifying a received signal in the W-CDMA receiver circuit, a low-noise amplifier (LNA) 7 for amplifying a received signal in the GSM receiver circuit, a duplexer (DUP) 3 for separating and combining of signals of the W-CDMA transmission system and the W-CDMA receiving system, and an antenna switch (ANT-SW) 2 for selectively switching over among the GSM transmission system, the GSM receiving system and the W-CDMA transmission and receiving system. Moreover, a band-pass filter 5 for passing only the desired received signal therethrough and suppressing the interference wave component is provided at the preceding stage of the LNA 7 which is one of the GSM receiving system.

The transmission output power of each transmitter circuit of the multi-mode communication apparatus having the above-mentioned configuration is controlled to adaptively be changed in accordance with the arrival power to the base station and the communication quality. Moreover, the band-pass filter 5 provided for the duplexer 3 of the W-CDMA communication system and the receiver circuit of the GSM system has been generally used which has a steep transmission frequency characteristic at a fixed cutoff frequency, regardless of the interference wave level, and the input and output impedances thereof is matched to an impedance of 50Ω at the pass-band frequency.

In the conventional multi-mode communication apparatus as described above, such a problem occurs that a transmission signal outputted from the transmitter circuit of one communication system leaks to the receiver circuit of the other communication system, and deteriorates and damages the device such as the LNA which is one of the receiver circuit In particular, when an identical frequency band has been used by the W-CDMA system and the GSM system (e.g., 3G Band II of the W-CDMA system and PCS1900 of the GSM system etc.), the leakage power is scarcely suppressed by the band-pass filters 5 of the duplexer 3 of the W-CDMA communication system and the receiving system of the GSM communication system. Moreover, since the impedance is matched to 50Ω at the pass-band frequency, an excessive voltage is applied to the input part of the LNA of the receiving system.

In order to dissolve such problems described above, an attempt to insert a band-pass filter that can control the cutoff frequency at, for example, the preceding stage of the LNA which is one of the receiving system of each communication system has been proposed (e.g., See Japanese patent laid-open publication JP 2006-197368 A). However, there has been such another problem that, since the leakage power of the transmission signal of the other communication system is suppressed and a loss of the desired received signal is generated not a little when such a filter is inserted, and this leads to reduction in the receiving sensitivity.

Moreover, although it is possible to suppress the leakage power to the receiver circuit of the other communication system by improving the suppression level of the interference wave component of the antenna switch 2, it is necessary to constitute the antenna switch of a multi-sage connection in the case, and there has been a problem that a reduction in the receiving sensitivity due to the loss of the desired received signal is also disadvantageously incurred in this case.

### SUMMARY OF THE INVENTION

An essential object of the present invention is to solve the problems as described above and provide a multi-mode communication apparatus that independently has transmitter and receiver circuits of the W-CDMA system and the GSM system to comply with both the W-CDMA and GSM communication systems, the apparatus capable of preventing the devices of LNA etc. which is one of the receiving system of the other communication system from being deteriorated and damaged by the leakage of the transmission signal of one communication system to the receiving system of the other communication system, suppressing the loss at the desired frequency during receiving to a minimum and allowing a satisfactory receiving sensitivity to be obtained.

In order to achieve the aforementioned objective, according to one aspect of the present invention, there is provided a multi-mode communication apparatus comprising independent transmitter circuits and receiver circuits of a W-CDMA system and a GSM system, which are capable of complying with communication systems of the W-CDMA system and the GSM system, respectively. The multi-mode communication apparatus includes first and second switching devices, and a control circuit. The first switching device is connected between a ground and an input terminal of a first low-noise amplifier of the receiver circuit of the W-CDMA communication system, and the first switching device is selectively turned on and off in accordance with a first control signal. The second switching device is connected between the ground and an input terminal of a second low-noise amplifier of the receiver circuit of the GSM communication system, and the second switching device being selectively turned on and off in accordance with a second control signal. The control circuit generates and outputs first and second control signals for controlling turning-on and -off of the first and second switching devices, respectively.

The multi-mode communication apparatus preferably further includes first and second impedance elements. The first impedance element has a predetermined impedance, and is connected between the first switching device and the ground. The second impedance element has the predetermined impedance, and is connected between the second switching device and the ground.

Alternatively, the first impedance element has a predetermined impedance, and is connected between the input terminal of the first low-noise amplifier and the first switching device. The second impedance element has the impedance, and is connected between the input terminal of the second low-noise amplifier and the second switching device.

In the above-mentioned multi-mode communication apparatus, the control circuit generates and outputs the first control signal for controlling the first switching device to be turned on a predetermined first interval before start of transmission of the transmitter circuit of the GSM system, and then, to be turned off a predetermined second interval after end of transmission of the transmitter circuit of the GSM system.

Alternatively, the control circuit generates and outputs the second control signal for controlling the second switching device to be turned on a predetermined third interval before start of transmission of the transmitter circuit of the W-CDMA system, and then, to be turned off a predetermined fourth interval after end of transmission of the transmitter circuit of the W-CDMA system.

With the above arrangement, the switching device provided at the input part of the LNA which is one of the receiving system of the other communication system is controlled to be turned on during transmission of one communication system, and then, the input part of the LNA has a low impedance and the leaking transmission signal is suppressed. This leads to preventing the devices of the LNA and so on from being deteriorated and damaged.

### BRIEF DESCRIPTION OF THE DRAWINGS

These and other objects and features of the present invention will become clear from the following description taken in conjunction with the preferred embodiments thereof with reference to the accompanying drawings throughout which like parts are designated by like reference numerals, and in which:

FIG. 1 is a block diagram of a wireless circuit of a conventional multi-mode communication apparatus compliant with W-CDMA/GSM;

FIG. 2 is a block diagram of a portion pertaining to the present invention of the wireless circuit of a multi-mode communication apparatus compliant with W-CDMA/GSM according to a first preferred embodiment of the present invention;

FIG. 3 is a block diagram of a wireless circuit of a multi-mode communication apparatus compliant with W-CDMA/GSM according to a second preferred embodiment of the present invention;

FIG. 4 is a graph showing a transmission frequency characteristic of a duplexer 3 when each of input and output impedances of the duplexer 3 of the multi-mode communication apparatus compliant with W-CDMA/GSM according to the preferred embodiments of the present invention are matched to an impedance of 50Ω;

FIG. 5 is a graph showing a transmission frequency characteristic of the duplexer 3 when the output impedance of the duplexer 3 of the multi-mode communication apparatus compliant with W-CDMA/GSM according to the preferred embodiments of the present invention is changed from 50Ω;

FIG. 6 is a timing chart showing an operating timing of a GSM transmitter circuit 10 and a control signal 14a for a switching device 12 of the multi-mode communication apparatus compliant with W-CDMA/GSM according to the preferred embodiments of the present invention;

FIG. 7 is a block diagram of a wireless circuit of a multi-mode communication apparatus compliant with W-CDMA/GSM according to a third preferred embodiment of the present invention; and

FIG. 8 is a timing chart showing an operating timing of a W-CDMA transmitter circuit 8 and a control signal 14b for a switching device 13 of the multi-mode communication apparatus compliant with W-CDMA/GSM according to the preferred embodiments of the present invention.

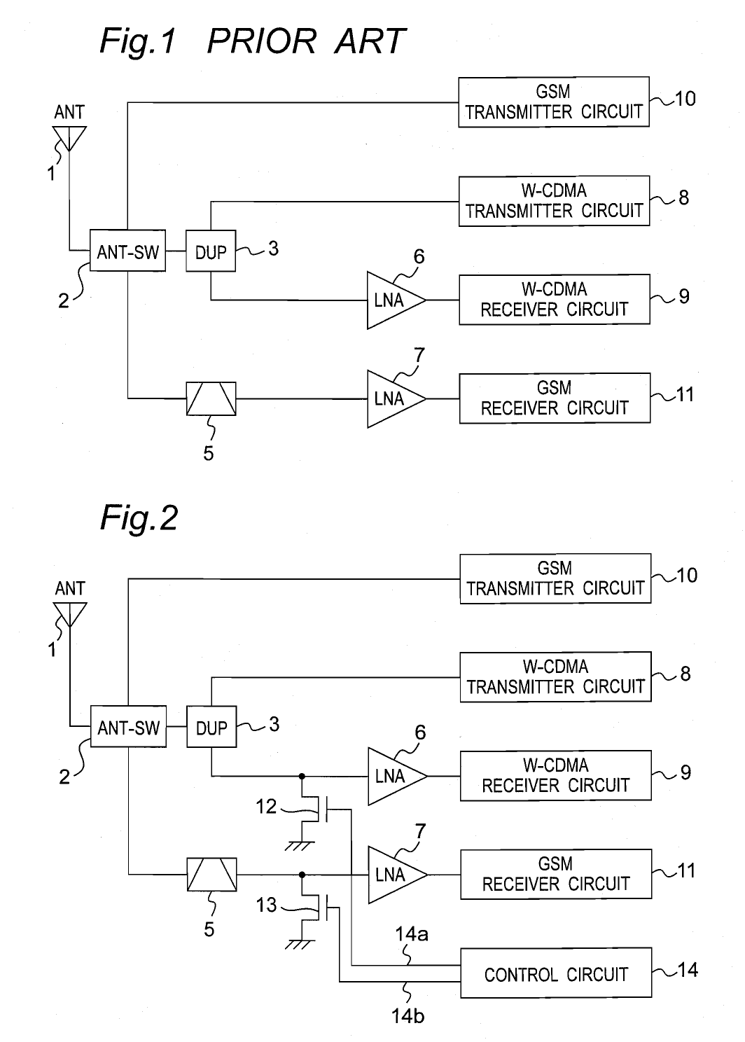

### DETAILED DESCRIPTION OF THE PREFERRED EMBODIMENTS

Preferred embodiments according to the present invention will be described below with reference to the attached drawings.

FIG. 2 is a block diagram showing an implemental example of a multi-mode communication apparatus compliant with W-CDMA/GSM according to a first preferred embodiment of the present invention. Referring to FIG. 2, the multi-mode communication apparatus of the present preferred embodiment includes a transmitter circuit 8 for performing a transmission processing during communication in a W-CDMA communication system, a receiver circuit 9 for performing a receiving processing during communication in the W-CDMA communication system, a transmitter circuit 10 for performing a transmission processing during communication in a GSM communication system, a receiver circuit 11 for performing a receiving processing during communication in the GSM communication system, an LNA 6 for amplifying a received signal in the W-CDMA receiver circuit, an LNA 7 for amplifying a received signal in the GSM receiver circuit, a duplexer 3 for separating and combining signals of the W-CDMA transmission system and the W-CDMA receiving system, and an ANT-SW 2 for selectively switching over among the GSM transmission system, the GSM receiving system and the W-CDMA transmission and receiving system. Moreover, a band-pass filter 5 for passing only the desired received signal and suppressing the interference wave component is provided at a preceding stage of the LNA 7 which is one of the GSM receiving system.

Moreover, a switching device 12 is connected between ground and the input terminal of the LNA 6 which is one of the receiving system of the W-CDMA communication system, and can be selectively turned on and off in accordance with a control signal 14a from the control circuit 14. A switching device 13 is connected between the ground and the input terminal of the LNA 7 which is one of the receiving system of the GSM communication system, and can be selectively turned on and off in accordance with a control signal 14b. A control circuit 14 generates and outputs the control signals 14a and 14b for respectively controlling the turning-on and -off of the switching devices 12 and 13. The switching device 12 is made of a MOS FET device or a bipolar transistor device which is integrated on the same IC chip as that of the LNA 6. Moreover, the switching device 13 is also made of a MOS FET device or a bipolar transistor device which is integrated on the same IC chip as that of the LNA 7.

The operation of the multi-mode communication apparatus of the present embodiment will be described below mainly with reference to an example of a control method of the switching device 12. The description is herein made by taking the control of the switching device 12 provided at the input terminal of the LNA 6 that constitutes the receiving system of the W-CDMA communication system as an example on the assumption that the W-CDMA communication system is 3G Band IT (1.7 GHz band) and the GSM communication system is PCS1900.

First of all, for the operating interval of the GSM communication system, a transmission signal outputted from the GSM transmitter circuit 10 is transmitted from an antenna 1 via the ANT-SW 2. In this case, the transmission signal leaks to the receiving system of the W-CDMA communication system via the ANT-SW 2 and the duplexer 3.

The transmission signal of the GSM communication system of PCS1900 has a frequency band of 1850 MHz to 1910 MHz. Assuming that the maximum output power of the transmitter circuit of the GSM communication system is +37 dBm and isolation from the GSM transmission system to the W-CDMA transmission and receiving system at the ANT-SW 2 is 20 dB, then a transmission signal of +17 dBm leaks to the duplexer 3. In this case, the signal of the frequency band of 1850 MHz to 1880 MHz common to the frequency band of 1845 MHz to 1880 MHz of the received signal in the 1.7 GHz band of the W-CDMA system within the frequency band of 1850 MHz to 1910 MHz of the transmission signal is the pass-band of the duplexer 3, and therefore, the signal is scarcely attenuated in the duplexer 3. Assuming that the pass-band of the duplexer 3 has a loss of about 2 dB, then a signal of the maximum +15 dBm leaks to the LNA 6 which is one of the receiving system.

For the operating interval of GSM transmission when an excessive signal is inputted to the LNA 6 that constitutes the receiving system of the W-CDMA communication system as described above, the control signal 14a is outputted from the control circuit 14, where the control signal 14a makes the switching device 12 connected between the input terminal of the LNA 6 and the ground become the ON-state. By turning on the switching device 12, the input terminal of the LNA 6 becomes a low impedance, and the signal power leaking from the transmission system of the GSM communication system is suppressed.

The impedance seen from the input terminal of the LNA 6 toward the duplexer 3 in the frequency band of the leaking transmission signal is matched approximately to 50Ω when the switching device 12 is in the OFF-state. Therefore, assuming that the impedance when the switching device 12 is in the ON-state is equal to or smaller than 1Ω, and then, the power of the signal inputted to the LNA 6 can be suppressed below 0 dBm.

As a result, the deterioration and the damage of the LNA 6 can be prevented. Moreover, during communication in the W-CDMA communication system, the control signal 14a is outputted from the control circuit 14, where the control signal 14a makes the switching device 12 becomes the OFF-state Since the switching device 12 is made of the device integrated on the same IC chip as that of the LNA 6, and has very small parasitic capacitance, resistance and so on, the loss of the desired received signal due to the switching device 12 can be suppressed to the minimum when the switching device 12 is in the OFF-state, and a satisfactory receiving sensitivity can be obtained. Moreover, the condition of turning on the switching device 12 is not limited to the operating interval of GSM transmission, and the switching device may be controlled to be consistently in the ON-state for a receiving standby interval of the W-CDMA system including the operating interval of GSM receiving.

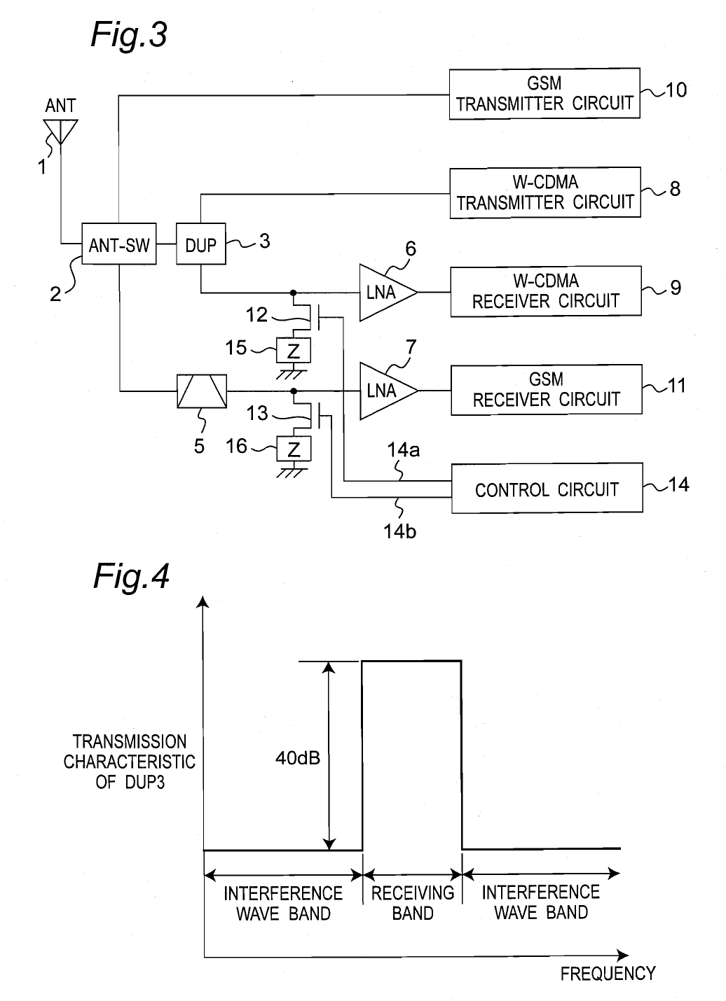

Although the switching devices 12 and 13 are directly connected between the input terminals of the LNAs 6 and 7 and the ground in the above-mentioned first preferred embodiment, respectively. The present invention is not limited to this, and the switching devices 12 and 13 may be connected to the ground via an impedance element 15 or 16 each having a predetermined impedance as shown in FIG. 3 of a second preferred embodiment.

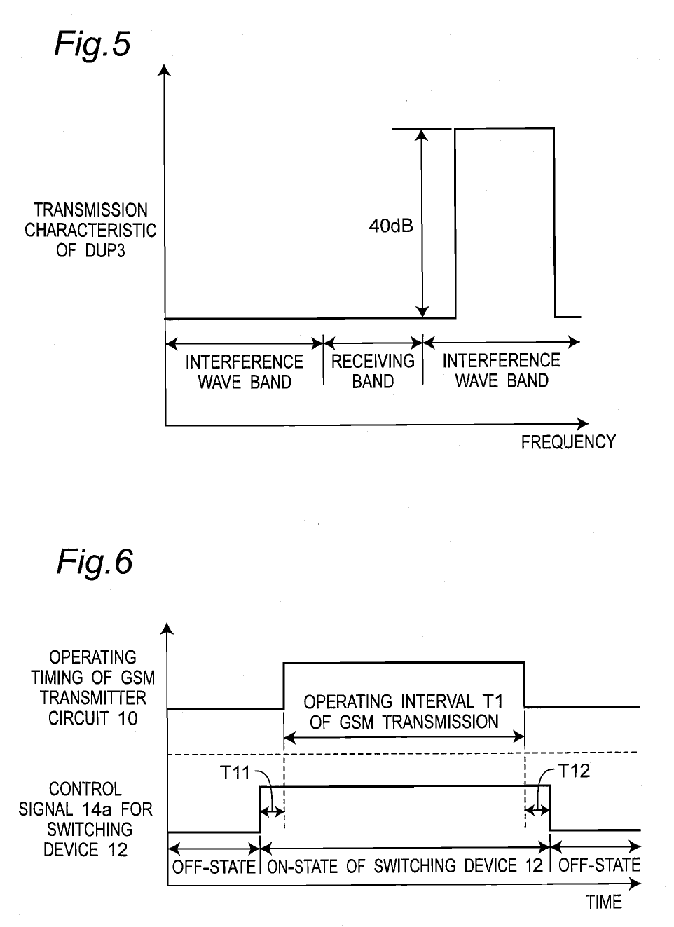

The duplexer 3, which separates the W-CDMA transmission and receiving systems, has a very steep band-pass characteristic that passes only the frequency band of the desired transmission signal and received signal, and the input and output impedances of the duplexer 3 are each matched to the impedance of 50Ω at the frequencies in the pass-band. FIG. 4 is a graph showing one example of the transmission frequency characteristic of the duplexer 3 when the input and output impedances of the duplexer 3 is each matched to 50Ω. The duplexer 3 has a characteristic such that its cutoff frequency is changed by a change of the impedance in the preceding and succeeding stages thereof, and therefore, the duplexer 3 has such a feature that the transmission frequency characteristic in the pass-band deteriorates as a consequence of the change of the cutoff frequency when the impedances in the preceding and succeeding stages largely change from 50Ω. Therefore, by controlling the switching device 12 to turn on for the operating interval of GSM transmission or during GSM communication in a manner similar to that of the case of the above implemental example to thereby change the impedance in the succeeding stage of the duplexer 3 from 50Ω, it is possible to change the cutoff frequency of the duplexer 3 and prevent the leakage of the transmission signal to the input terminal of the LNA 6 as shown in FIG. 5.

Moreover, since the band-pass filter 5 of the GSM receiving system has a characteristic similar to that of the duplexer 3, the leakage of the transmission signal to the input terminal of the LNA 7 can be prevented with the above configuration.

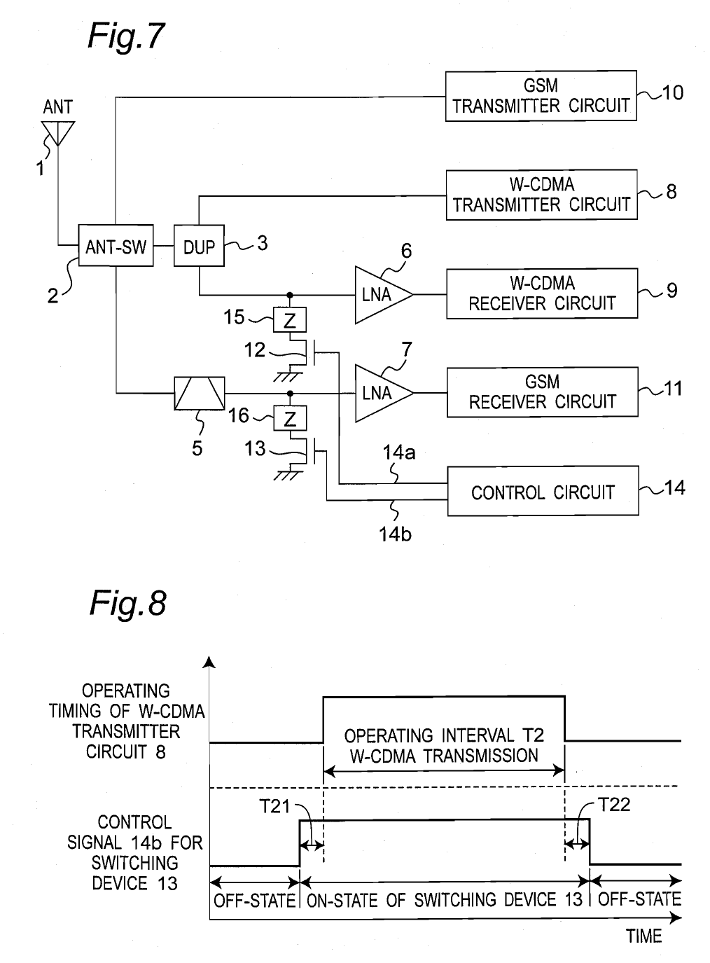

The impedance devices 15 and 16 are connected between the switching devices 12 and 13 and the ground as shown in FIG. 3, respectively. The present invention is not limited to this, and the impedance devices 15 and 16 may be connected between the input terminals of the LNAs 6 and 7 and the switching devices 12 and 13, respectively, as shown in FIG. 7 of a third preferred embodiment.

In the above-mentioned preferred embodiments, regarding the timing of controlling the switching device 12, the switching device 12 is controlled so that the switching device 12 becomes the ON-state a predetermined interval T11 before the start of the GSM transmission as indicated by the interval T1, and then, the switching device 12 becomes the OFF-state a predetermined interval T12 after the end of the GSM transmission as shown in FIG. 6. The switching device 12 can reliably become the ON-state for the operating interval of GSM transmission even when there is a difference for a time margin required for the rise and fall between the GSM transmitter circuit 10 and the switching device 12. Therefore, the deterioration and the damage of the LNA 6 can more reliably be prevented.

Alternatively, regarding the timing of controlling the switching device 13, the switching device 13 is controlled so that the switching device 13 becomes the ON-state a predetermined interval T21 before the start of the W-CDMA transmission as indicated by the interval T111, and then, the switching device 13 becomes the OFF-state a predetermined interval T22 after the end of the W-CDMA transmission as shown in FIG. 8. The switching device 13 can reliably become the ON-state for the operating interval of W-CDMA transmission even when there is a difference for a time margin required for the rise and fall between the W-CDMA transmitter circuit 8 and the switching device 13. Therefore, the deterioration and the damage of the LNA 7 can more reliably be prevented.

### INDUSTRIAL APPLICABILITY

The present invention is useful as a multi-mode communication apparatus having independent transmitter circuits and receiver circuits of the W-CDMA system and the GSM system to comply with both the communication systems of the W-CDMA system and the GSM system, where the multi-mode communication apparatus can suppress the leakage of the transmission signal of one communication system to the receiving system of the other communication system. The multi-mode communication apparatus can prevent the deterioration and the damage of the devices of LNA and so on that constitute the other communication system, suppressing the loss during receiving to the minimum, having such an advantageous effect of obtaining a satisfactory receiving sensitivity and complying with a plurality of communication systems in a manner similar to that of the communication apparatus compliant with W-CDMA/GSM.

Although the present invention has been fully described in connection with the preferred embodiments thereof with reference to the accompanying drawings, it is to be noted that various changes and modifications are apparent to those skilled in the aft. Such changes and modifications are to be understood as included within the scope of the present invention as defined by the appended claims unless they depart therefrom.

What is claimed is:

1. A multi-mode communication apparatus comprising independent transmitter circuits and receiver circuits of a W-CDMA system and a GSM system, which are capable of complying with communication systems of the W-CDMA system and the GSM system, respectively, said multi-mode communication apparatus comprising:
a first switching device connected between a ground and an input terminal of a first low-noise amplifier of the receiver circuit of the W-CDMA communication system, said first switching device being selectively turned on and off in accordance with a first control signal;
a second switching device connected between the ground and an input terminal of a second low-noise amplifier of the receiver circuit of the GSM communication system, said second switching device being selectively turned on and off in accordance with a second control signal; and
a control circuit for generating and outputting first and second control signals for controlling turning-on and -off of the first and second switching devices, respectively.

2. The multi-mode communication apparatus as claimed in claim 1, further comprising:
a first impedance element having a predetermined impedance, said first impedance element connected between the first switching device and the ground; and
a second impedance element having the predetermined impedance, said second impedance element connected between the second switching device and the ground.

3. The multi-mode communication apparatus as claimed in claim 1, further comprising:
a first impedance element having a predetermined impedance, said first impedance element connected between the input terminal of the first low-noise amplifier and the first switching device; and
a second impedance element having the impedance, said second impedance element connected between the input terminal of the second low-noise amplifier and the second switching device.

4. The multi-mode communication apparatus as claimed in claim 1,
wherein the control circuit generates and outputs the first control signal for controlling the first switching device to be turned on a predetermined first interval before start of transmission of the transmitter circuit of the GSM system, and then, to be turned off a predetermined second interval after end of transmission of the transmitter circuit of the GSM system.

5. The multi-mode communication apparatus as claimed in claim 1,
wherein the control circuit generates and outputs the second control signal for controlling the second switching device to be turned on a predetermined third interval before start of transmission of the transmitter circuit of the W-CDMA system, and then, to be turned off a predetermined fourth interval after end of transmission of the transmitter circuit of the W-CDMA system.

6. The multi-mode communication apparatus as claimed in claim 2,
wherein the control circuit generates and outputs the first control signal for controlling the first switching device to be turned on a predetermined first interval before start of transmission of the transmitter circuit of the GSM system, and then, to be turned off a predetermined second interval after end of transmission of the transmitter circuit of the GSM system.

7. The multi-mode communication apparatus as claimed in claim 2,
wherein the control circuit generates and outputs the second control signal for controlling the second switching device to be turned on a predetermined third interval before start of transmission of the transmitter circuit of the W-CDMA system, and then, to be turned off a predetermined fourth interval after end of transmission of the transmitter circuit of the W-CDMA system.

8. The multi-mode communication apparatus as claimed in claim 3,
wherein the control circuit generates and outputs the first control signal for controlling the first switching device to be turned on a predetermined first interval before start of transmission of the transmitter circuit of the GSM system, and then, to be turned off a predetermined second interval after end of transmission of the transmitter circuit of the GSM system.

9. The multi-mode communication apparatus as claimed in claim 3,
wherein the control circuit generates and outputs the second control signal for controlling the second switching device to be turned on a predetermined third interval before start of transmission of the transmitter circuit of the W-CDMA system, and then, to be turned off a predetermined fourth interval after end of transmission of the transmitter circuit of the W-CDMA system.
